(19) United States
(12) Patent Application Publication
(10) Pub. No.: US 2024/0297460 A1
(43) Pub. Date: Sep. 5, 2024

(54) Plug Arrangement

(71) Applicant: TE Connectivity Solutions GmbH, Schaffhausen (CH)

(72) Inventors: Carsten BUCK, Bensheim (DE); Maximilian VEIHL, Bensheim (DE)

(73) Assignee: TE Connectivity Solutions GmbH, Schaffhausen (CH)

(21) Appl. No.: 18/591,035

(22) Filed: Feb. 29, 2024

(30) Foreign Application Priority Data
Mar. 3, 2023 (DE) 102023105353.1

(51) Int. Cl. H01R 13/629

(52) U.S. Cl. CPC H01R 13/62955

(57) ABSTRACT

A plug arrangement is shown, comprising a housing part for a plug which can be plugged together with a mating plug along a plugging direction, and a pivoting lever which can be attached to the housing part and, in the attached state, can be pivoted from an initial position into an end position, the arrangement having a blocking element which can be transferred from a blocking position into a release position, which, in the blocking position, blocks pivoting of the pivoting lever out of the initial position and, in the release position, releases pivoting of the pivoting lever, the blocking element having a driving element which can be actuated by the mating plug and with which the blocking element is transferred by the mating plug into the blocking position

This application claims priority to DE Application Ser. No. 102023105353.1 filed on Mar. 3, 2023 which is incorporated herein by reference in its entirety.

The invention relates to a plug arrangement comprising a housing part for a plug which can be plugged together with a mating plug along a plugging direction and a pivoting lever which can be attached to the housing part.

The pivoting lever can be used, for example, to move the plug relative to the mating plug, such as to press the plug into the mating plug or vice versa. Alternatively or additionally, the pivoting lever can be used to secure the plug to the mating plug.

Solutions are known in which the pivoting lever can be pivoted from an initial position to an end position in the attached state, wherein the arrangement has a blocking element that can be transferred from a blocking position to a release position, which blocks pivoting of the pivoting lever out of the initial position in the blocking position and releases pivoting of the pivoting lever in the release position.

However, these solutions are often complex in assembly and disassembly.

The object of the invention is to provide a solution which allows easy assembly and disassembly.

According to the invention, this is solved by the blocking element having a driving element which can be actuated by the mating plug and with which the blocking element is transferred by the mating plug into the blocking position.

This solution has the advantage that when the plug is disconnected from the mating plug, the blocking element can be pulled into the blocking position by the mating plug. When it is subsequently plugged in, there is no need to adjust the pivoting lever. This simplifies assembly and disassembly.

The solution according to the invention can be further improved with the following further developments and configurations, each of which is individually preferred and can be combined with one another as desired.

Transferring the blocking element to the blocking position can take place automatically when the plug is disconnected from the mating plug. With such a configuration, an additional step of manual or mechanical actuation for transfer can be dispensed with.

According to a further configuration, the blocking element can be transferred from the release position to the blocking position during disconnection. As a result, operation can be simplified, since, for example, an additional step is not required to manually transfer the blocking element from the release position to another position, out of which it is then transferred to the blocking position.

The driving element can be part of a driving mechanism that also includes other elements, for example of the mating plug. Either existing parts or areas of the mating plug can be used in the driving mechanism so that previous mating plugs can continue to be used. In other configurations, specially configured new elements can be present on the mating plug, which are part of the driving mechanism.

In the initial position, it may be possible to connect the plug to the mating plug, in particular to plug it in or plug it together along a plugging direction.

In the end position, the plug can be secured to the mating plug, in particular against being pulled apart in the opposite plugging direction.

According to a preferred configuration, the driving element can have form-fit elements that interact with the mating plug. Such a solution enables simple and safe driving. In particular, form-fit elements acting against the plugging direction can be present on the driving element. The mating plug can have (form-fit) mating elements that interact with the form-fit elements on the driving element. The form-fit elements can be projections, recesses, stops or latching elements, for example. In particular, these can act against the plugging direction. They can have form-fit surfaces or abutment surfaces that point against the plugging direction. For example, these run perpendicularly to the plugging direction or slightly inclined to a plane that runs perpendicularly to the plugging direction. Corresponding mating elements can be present on the mating plug, where the surfaces run in the opposite direction. In particular, the surfaces on the interacting form-fit elements can be at least partially complementary to each other.

Alternatively or additionally to the driving by a form fit, other principles can also be used, for example a force fit, i.e. that a force acting perpendicularly to the plugging direction between two interacting surfaces is large enough to transfer the blocking element into the blocking position due to the existing friction.

Another possible principle is driving by sufficiently large magnetic or electrical forces between two interacting elements.

In one possible configuration, the driving element can be configured to interact with the mating plug only in the initial position. Outside the initial position, in particular in the end position, the driving element can have no driving effect for the mating plug. For example, form-fit elements can be disengaged.

The driving element can be specially configured to be automatically activated when the pivoting lever is moved to the initial position, i.e. to achieve a driving effect for the mating plug. In the case of driving by a form fit, for example, a form fit can be present in the activated state, i.e. corresponding parts are in engagement with each other. On the other hand, the driving element can be configured to be automatically deactivated when the pivoting lever is pivoted out of the initial position and/or transferred to the end position. Deactivated here means that no or insufficient driving effect is achieved for the mating plug. In the special case of driving by a form fit, there is no corresponding form fit in the activated state, i.e. corresponding elements are not in engagement with each other.

In another configuration, the driving element can also be activated outside the initial position, in particular in all positions of the pivoting lever.

According to a preferred embodiment, the driving element can be configured to be deactivated when the blocking element has reached or exceeded the blocking position. As a result, simple operation is possible. The plug can then be easily disconnected from the mating plug. Deactivation can take place automatically when the blocking position is reached. This eliminates the need for manual or mechanical deactivation in an additional step.

Alternatively or additionally, the driving element can be configured to be deactivated when a defined tensile force between the plug and the mating plug is exceeded. Here too, deactivation can be automatic. Due to this solution, the plug can be easily disconnected from the mating plug by pulling the two apart. As long as the defined pulling force has not yet been reached, the blocking element is driven by the mating plug. When the blocking position is reached or exceeded, the tensile force increases and the driving element is deactivated. The size of such a defined tensile force can be specified in national, international, company-internal or other standards.

The driving element can, for example, be configured such that a defined counterforce is generated as soon as the blocking position is reached or exceeded. Before the blocking position is reached, the counterforce can, for example, be mainly defined by the sliding friction that occurs when the blocking element moves relative to other parts, for example the pivoting lever or the housing part. As soon as the blocking position is reached, an additional mechanism can take effect, for example a form fit on surfaces that run perpendicularly to the plugging direction or run more or less inclined to the vertical. If, in the latter case, at least one of the surfaces involved is attached to an element that can be deflected perpendicularly to the plugging direction, for example, a deflection perpendicular to the plugging direction can be achieved by applying a correspondingly high force. This allows the surfaces to be automatically disengaged. The strength of a force for sufficient deflection of a deflectable element can be varied as desired by selecting the appropriate lengths, thicknesses and widths of the material. The angle of inclination of the surfaces can also be adjusted accordingly.

The blocking element can be movably mounted on the pivoting lever, in particular displaceably mounted. Bearing elements can be provided on the blocking element and/or on the pivoting lever for this purpose. The bearing elements can be formed for example as projections or recesses, such as strips or grooves.

The blocking element and the pivoting lever can be separate parts. They can be manufactured separately and then attached to each other. They can be made of different materials, for example to be able to perform the various functions appropriately.

In a preferred configuration, the blocking element can be guided on the pivoting lever. The blocking element and/or the pivoting lever can have rotational or translational, in particular linear, guide elements.

The blocking element can move with the pivoting lever. One of the two parts can be configured such that when the pivoting lever is pivoted, the blocking element is also moved.

According to one embodiment, the blocking element can have a securing element that is configured to automatically secure the blocking element to the housing part when the pivoting lever reaches the end position. In this case, securing means, in particular, securing against unintentional deflection out of the end position. The pivoting lever can be indirectly secured to the housing part via the blocking element.

A securing element can, for example, be a latching element that enables latching with the housing part. The securing element can be part of a securing mechanism that either uses existing housing parts or elements or comprises at least one new, specially configured mating element on the housing part.

In order to minimize the space required and/or to enable automatic securing, the blocking element can be transferred to the blocking position when the pivoting lever is in the end position. In another configuration, the blocking element can be transferred to an intermediate position between the blocking position and the release position, where it can be secured or thereby reduce the space required.

The plug arrangement can have a stopping mechanism that stops the blocking element from being transferred out of the release position, in particular into the blocking position, if the plug is not fully plugged together with the mating plug. The stopping mechanism can have a stopping element on the blocking element that can be released by the mating plug. This can be, for example, a latching element that can be deflected by a projection on the mating plug, which stops the transfer when it is not in the deflected state. In the event of an attempted transfer, the stopping element can abut against a mating element that is attached to the pivoting lever, for example. The stopping mechanism is preferably configured such that it is possible to transfer the blocking element back to the release position.

According to a preferred configuration, a detaching element, with which the securing element is detached by the securing element, can be arranged to be inaccessible in the blocking position. This can prevent unintentional detachment. Inaccessible here means, in particular, inaccessible to a user or an apparatus. This can be defined, for example, by the fact that the element cannot be reached with a standardized test finger. In particular, access along a release direction should not be possible in the blocking position. The release direction can be defined as the direction along which a force must be exerted on the detaching element in order to detach the securing element. In particular, the detaching element can only be completely accessible in the release position. In other positions, the detaching element can be at least partially accessible.

One possible embodiment is that the detaching element is covered by the pivoting lever in the blocking position. In other words, at least along the release direction, part of the pivoting lever can cover or shield the detaching element.

In order to increase the lever length and thus reduce the force required for pivoting, the blocking element can be an extension element for the pivoting lever, at least in the release position. In other positions, in particular the blocking position, there can be no significant extension of the lever length by the blocking element. A factor of maximum 1.1 of the lever length of the pivoting lever cannot be considered a significant extension. In this context, the lever length can be measured between a pivot axis (such as a central axis of a shaft) and an actuation section and/or an outer end of the pivoting lever.

One possible configuration of driving is that the blocking element is pulled into the blocking position by the mating plug. This can enable simple and safe power transmission.

In an alternative configuration, driving can be configured as pressing, i.e. the blocking element is pressed or pushed into the blocking position by the mating plug.

In addition to the preferably automatic transfer to the blocking position, the plug arrangement can be configured such that the blocking element can be transferred, in particular moved, to the release position by the mating plug. This can be done automatically, for example, when the plug and mating plug are plugged together. As a result, operation is made easier. In particular, the blocking element can be transferred from the blocking position to the release position by the mating plug.

Analogous to the latching mechanism described for the driving element, there can also be a form fit in the plugging direction, which is automatically detached when a defined force is exceeded.

According to one possible configuration, the pivoting lever can only be rotationally movable relative to the housing part, but not translationally movable. This can simplify the construction.

The plug arrangement can additionally comprise at least one housing part of a mating plug.

Furthermore, the plug arrangement can have a pulling mechanism which pulls the plug towards the mating plug when the pivoting lever is transferred from the initial position to the end position. Such a pulling mechanism can, for example, be configured as a toothed mechanism with gearwheels, gear racks or the like, or as a spiral guide mechanism with a projection and a spiral guide.

Alternatively, the driving element can also be referred to as a return element, as it returns the blocking element to the blocking position.

In the following, the invention is explained in more detail by means of preferred configurations with reference to the drawings. The preferred further developments and configurations shown here are each independent of one another and can be combined with one another as desired, depending on how this is necessary in the application.

### It is Shown by:

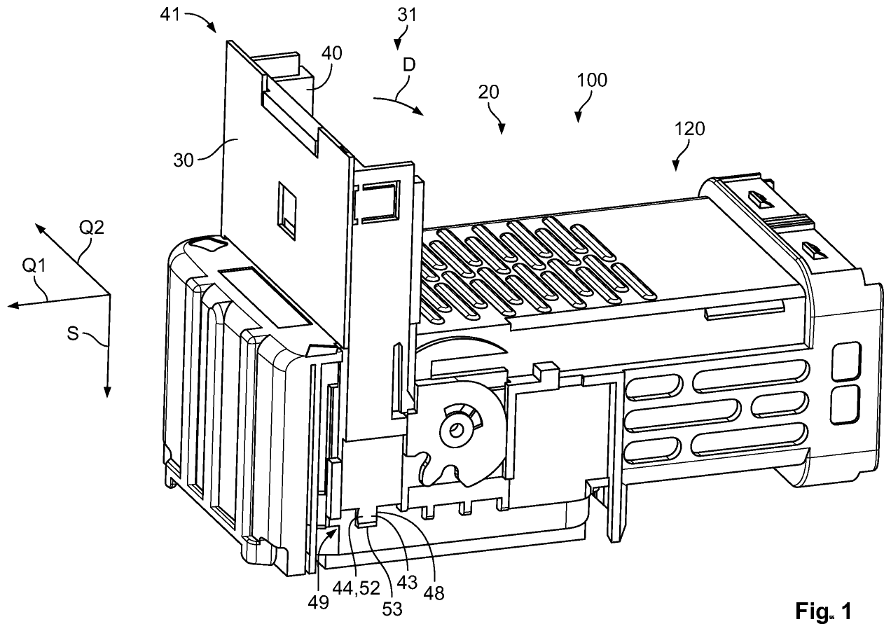

FIG. 1 a schematic, partially sectioned perspective view of a plug arrangement with a pivoting lever in an initial position and a blocking element in a blocking position;

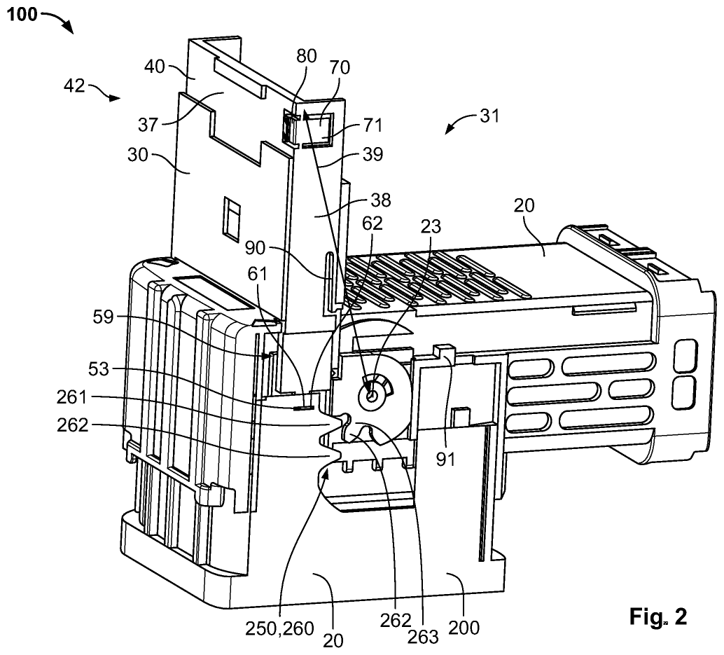

FIG. 2 a schematic, partially sectioned perspective view of the plug arrangement from FIG. 1 with the pivoting lever in the initial position and the blocking element in a release position;

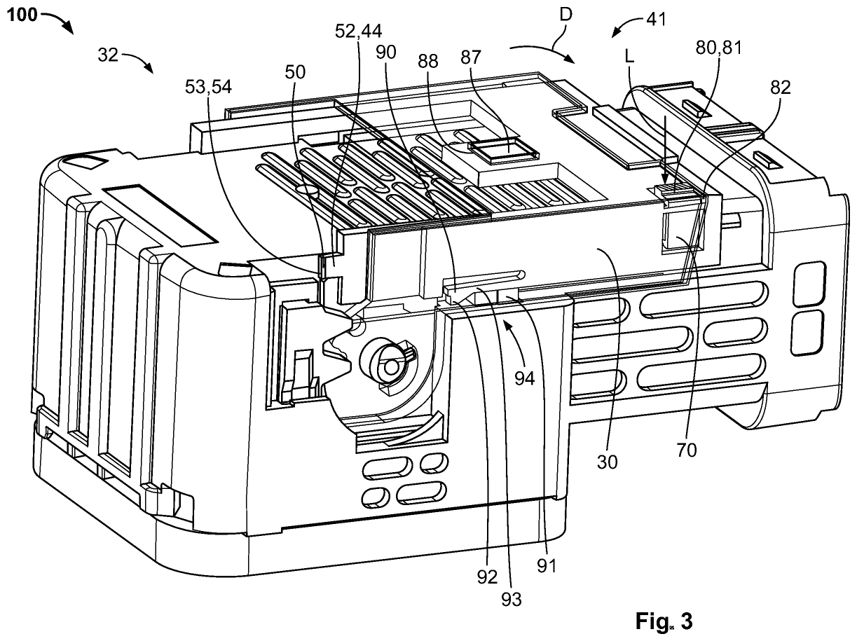

FIG. 3 a schematic, partially sectioned perspective view of the plug arrangement shown in FIGS. 1 and 2 with the pivoting lever in the end position and the blocking element in the blocking position;

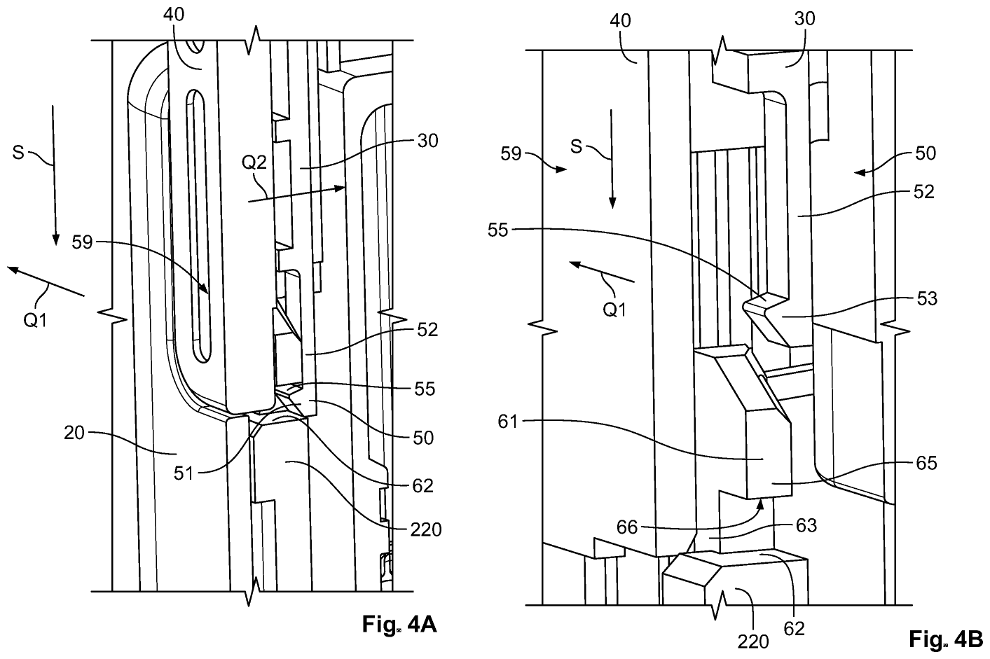

FIG. 4A a schematic, partially sectioned perspective view of a driving mechanism of the plug arrangement of FIGS. 1 to 3 in the latched state;

FIG. 4B a schematic, partially sectioned perspective view of the driving mechanism shown in FIG. 4A in a detached state;

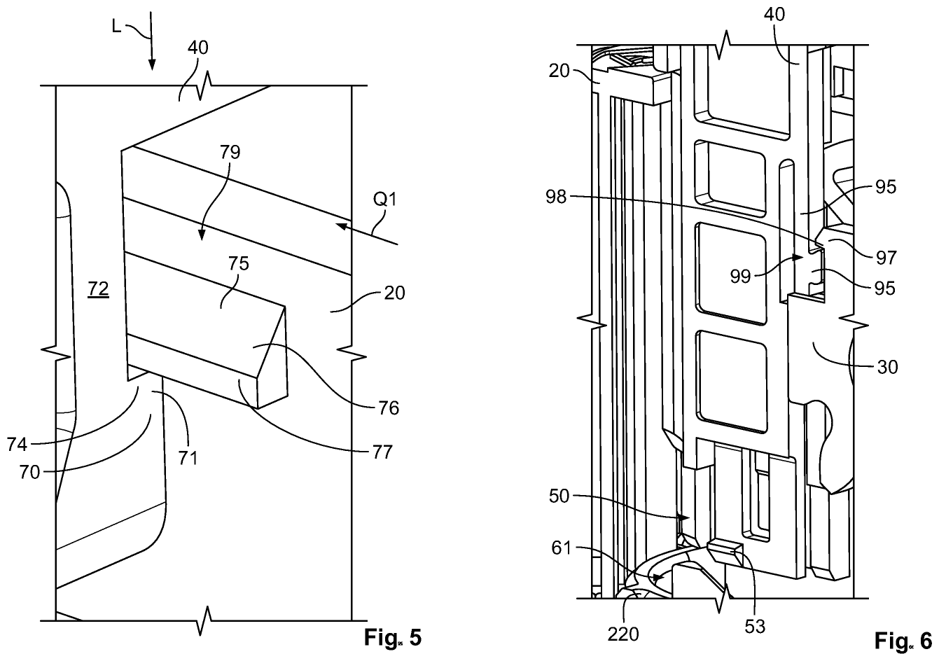

FIG. 5 a schematic perspective view of a latching mechanism of the embodiment of FIGS. 1 to 3; and

FIG. 6 a schematic, partially sectioned perspective view of a preferred configuration of a holding mechanism.

FIGS. 1 to 5 show a first embodiment of a plug arrangement 100. In FIG. 6, a special configuration of a holding mechanism 99 is shown, which can also be used in the first embodiment, for example.

The plug arrangement 100 comprises in each case a housing part 20 of a plug 120. The plug 120 can, for example, be an electrical plug with which power or signals are transmitted. For this purpose, further elements may be present on the plug 120, in particular electrical contact elements (not shown). The plug 120 shown can thus be connected to a cable and is then used to transmit the power or the signals to a mating plug 200. The mating plug 200 shown is configured as a header that can be mounted on a product housing, for example.

In other configurations, other plugs are also possible, for example for the transmission of optical signals, for pneumatic or hydraulic connections or similar. It is also possible to use connectors that are not necessarily plugged in.

The plug 120 is configured to be plugged together with the mating plug 200 along a plugging direction S. In a first step, the plug 120 is, for example, easily plugged together manually with the mating plug 200. In order to then generate a large pressing force or mating force, the plug arrangement 100 has a pivoting lever 30, which can be attached to the housing part 20. The pivoting lever 30 shown can only be moved rotationally relative to the housing part 20, thus pivoted. In other configurations, an at least partial translational relative mobility can also be provided, at least in some positions of the pivoting lever 30 relative to the housing part 20.

In order to move the plug 21 and the mating plug 200 towards each other, the plug arrangement 100 has a pulling mechanism 250, which is configured here as a toothed mechanism 260. Teeth 261, which are formed on a gear rack 262 on a housing part 220 of the mating plug 200 and on a gearwheel segment 263 on the pivoting lever 30, engage with one another and convert the pivot movement of the pivoting lever 30 along a pivoting direction L into a translational relative movement. Due to the lever effect, the force required for this, which is applied to an actuation section 37 of the pivoting lever 30, can be relatively low.

In the example shown, the pivoting lever 30 can be moved, in particular rotated, from an initial position 31 to an end position 32. Pivoting beyond the initial position 31 and the end position 32 can be prevented by the fact that the pivoting lever 30 abuts against stops. In other configurations, however, pivoting beyond the initial position 31 and/or the end position 32 may also be possible.

However, pivoting the pivoting lever 30 out of the initial position 31 is only possible if a blocking element 40 is in a release position 42. If, on the other hand, the blocking element 40 is in a blocking position 41, the pivoting lever 30 is blocked from pivoting relative to the housing part 20 by the blocking element 40. In the embodiment shown, the blocking element 40 is attached to the pivoting lever 30 and is guided so as to be displaceable relative thereto. The blocking position 41 and the release position 42 refer here to a relative position of the pivoting lever 30 to the blocking element 40. The blocking effect of the blocking element 40 is achieved here by a form-fit element 43 on the blocking element 40 in the form of a projecting arm 44 engaging in a recess 48 on the housing part 20.

In order to detach the blocking effect 49 achieved by the blocking element 40 and the recess 48, the blocking element 40 is moved in the direction away from a shaft 23 on the housing part 20 on which the pivoting lever 30 is mounted, thus in the example shown against the plugging direction S. This is achieved here by the housing part 220 of the mating plug 200 when it is plugged together with the plug 20. The blocking element 40 is thus automatically transferred to the release position 42 without any special additional action by a user or any apparatus on the blocking element 40.

Since the blocking element 40 simultaneously forms an extension element 35 for the pivoting lever 30, the lever length 39 is thereby extended and the force required for pivoting is further minimized. Furthermore, such a configuration has the advantage that in a transport state, as shown for example in FIG. 1, the lever length 39 is relatively short and thus the risk of damage is reduced. The lever length 39 is defined here as the distance between the actuation section 37, which lies between two lever sections 38, and a central axis or axis of rotation of the shaft 23. At the same time, the plug arrangement 100 is already held in a configuration necessary for the plugging process by the blocking mechanism 49. In particular, the pivoting position of the pivoting lever 30 is fixed in the initial position 31.

In order to secure the blocking element 40 against unintentional displacement out of the blocking position 41, a holding mechanism 99 (see, for example, the particularly preferred configuration in FIG. 6) can be provided. In the example shown, the holding mechanism 99 has a holding element 95 formed integrally with the rest of the blocking element 40, which in particular has an outwardly projecting and elastically inwardly deflectable projection 97, which can latch with a recess 96 and a projection 97 on the rotating lever or pivoting lever 30. Due to the fact that a surface 98 on the projection 97 does not run exactly perpendicularly to the direction of movement of the blocking element 40 relative to the pivoting lever 30, but is slightly inclined to it, the blocking effect is automatically canceled by the holding mechanism 99 if a force applied by the mating plug 20 and acting on the blocking element 40 exceeds a certain threshold. The projection 95 is then elastically deflected and disengages from the projection 97.

If the pivoting lever 30 is now pivoted from the initial position 31 along a direction of rotation D to the end position 32, which is offset by 90 degrees, it lies flat on the housing part 20. When the end position 32 is reached, the pivoting lever 30 is automatically fixed relative to the housing part 20 by a securing mechanism 79. This is achieved by a securing element 70 in the form of a latching element 71 on the blocking element 40 latching with a corresponding element 75 on the housing part 20. Both are configured as form-fit elements 74, 76 and achieve a form-fit between blocking element 40 and housing part 20 in the latched state. Due to the fact that the blocking element 40 in this state is only displaceable along a transverse direction Q1 parallel to an upper side of the housing 20 relative to the pivoting lever 30, the pivoting lever 30 is thereby indirectly fastened to the housing part 20.

The securing element 70 on the blocking element 40 is configured as a projection 73, which projects inwards from an arm 72 towards the housing 20. The element 75 on the housing part 20 is configured as a ledge 77, so that movement of the securing element 70 and thus of the blocking element 40 along the first transverse direction Q1 parallel to the upper side of the housing 20 is possible. The blocking element 40 can therefore be transferred back out of the release position 42 into the blocking position 41.

However, such a transfer is only possible if a stopping mechanism 94 is deactivated by the housing part 220 of the mating plug 20. Activation is effected by a projection 91 on the housing part 220, which projects through the housing part 20 of the plug 120 and elastically deflects a stopping element 90 on the blocking element 40 only when the plug 120 is fully plugged together with the mating plug 200 (here specifically the housing parts 20 and 220). The stopping element 90 here also comprises a projection 92, which projects from an elastically deflectable arm 93. The stopping element 90 is again integral with the rest of the blocking element 40.

As with the other mechanisms, an easy transfer back to a stopping position can be achieved by providing an inclined overrun slope on a side opposite a stopping side.

Advantageously, the stopping element 90 of the stopping mechanism 94 can simultaneously function as the holding element 95 of the holding mechanism 99. This reduces the complexity and weight and enables simple manufacture.

In order to detach the latching caused by the securing mechanism 79, a detaching element 80 is provided on the blocking element 40. This is configured as a pusher 81, in which pressing along a release direction L, which here runs perpendicularly to the upper side of the housing part 20, is converted into a detaching movement on the securing surface 70. The detaching element 80 is connected integrally with the securing element 70 and the rest of the blocking element 40. A bearing that allows sufficient mobility is achieved by thin material bridges 82.

In the state shown in FIG. 3, the blocking element 40 is already in the blocking position 41. There, the detaching element 80 is covered by the transparently shown pivoting lever 30. It is therefore not accessible to a user. A signal part 87 is visible to the user through an opening 88 on the pivoting lever 30, so that the user (or a suitable apparatus) can recognize that a complete plugging with a securing device is present.

The disconnection of the plug 120 from the mating plug 200 takes place in the reverse order, i.e. from FIG. 3 to FIG. 2 and then to FIG. 1. The blocking element 40 is moved relative to the pivoting lever 30 into the release position 42. By actuating the detaching element 80, the form fit between the locking element 40 and the housing part 20 is canceled, whereby the pivoting lever 30 can be moved back from the end position 32 against the first transverse direction Q1 to the initial position 31.

The plug arrangement 100 shown here advantageously also comprises a driving mechanism 59, with which the blocking element 40 is automatically transferred by the mating plug 200 from the release position 42 back to the blocking position 41 when the pivoting lever 30 is in the initial position 31 and the mating plug 202 is disconnected or unplugged from the plug 120. In the example shown, the driving mechanism 59 is only active in the initial position 31 of the pivoting lever 30. Outside the initial position 31, in particular in the end position 32, the driving mechanism 59 is deactivated.

The driving mechanism 59 is again based on a form-fit principle. A driving element 50 on the blocking element 40 engages in a form-fit manner in a recess 62 on the housing part 220 of the mating plug 200. An upper boundary of the recess 62 forms a mating element 61 for the driving element 50. The driving element 50 as well as the mating element 61 comprise an arm 52 or 63. A latching projection 53 of the driving element 50 serves as a form-fit element 54, which interacts with a form-fit element 65 on the housing 21 of the mating plug 200.

The embodiment shown is configured such that the driving mechanism 59 is automatically deactivated, i.e. in this case the form-fit elements 54, 65 are disengaged when the blocking position 41 is reached. This is achieved by the fact that a surface 55 on the form-fit elements 54 does not extend completely perpendicularly to the direction of the relative movement between the blocking element 40 and housing part 220, which is restricted by corresponding guide elements. Rather, the surface 55, which interacts with a surface 66 on the mating element 61 in the latched state, is slightly inclined to a plane that runs perpendicularly to this direction. By appropriately dimensioning the width, thickness and length of the arm 52 and the inclination of the surface 55, a defined force threshold can now be specified in view of the selected material, above which a force is converted by the mating plug 200 into a sufficient deflection of the latching projection 53 and this is then pressed out of engagement with the mating element 61. Before reaching the blocking position 41, the force applied by the mating plug 200 merely causes a displacement of the blocking element 40 relative to the pivoting lever 30. A much lower force is required for this, as only the friction between the blocking element 40 and the pivoting lever 30 needs to be overcome. The driving mechanism 59 automatically transfers the blocking element 40 to the blocking position 41 without any further action by a user, thereby fixing the pivoting lever 30 in the initial position 31 required for connection to the mating plug 30.

The holding mechanism 99 shown in FIG. 6 is based on the same principle of triggering from a certain force by an inclined surface, in this case the surface 98 on the projection 97.

In the example shown, the deflection of the latching projection 53 takes place in a second transverse direction Q2, which runs perpendicularly to the plugging direction. In other embodiments, such a deflection may also occur along the first transverse direction Q1, which runs perpendicularly to the plugging direction S and perpendicularly to the second transverse direction Q2.

According to the preferred configuration shown, elements of the blocking mechanism 49 also serve as elements of the driving mechanism 59. For example, the arm 44 of the blocking mechanism 49 is also the arm 52 of the driving element 50.

The various solutions and mechanisms shown (49, 59, 79, 94, 99) can be independent of one another and each represent independent inventive solutions.

### REFERENCE SIGNS

20 housing part
23 shaft
30 pivoting lever
31 initial position
32 end position
35 extension element
37 actuation section
38 lever section
39 lever length
40 blocking element
41 blocking position
42 release position
43 form-fit element
44 arm
48 recess
49 blocking mechanism
50 driving element
51 latching element
52 arm
53 latching projection
54 form-fit element
55 surface
59 driving mechanism
61 mating element
62 recess
63 arm
65 form-fit element
66 surface
70 securing element
71 latching element
72 arm
73 recess
74 form-fit element
75 element
76 form-fit element
77 ledge
79 securing mechanism
80 detaching element
81 pusher
82 material bridge
87 signal part
88 opening
90 stopping element
91 projection
92 projection
93 arm
94 stopping mechanism
95 holding element
96 recess
99 holding mechanism
100 plug arrangement
120 plug
200 mating plug
220 housing part
250 pulling mechanism
260 toothed mechanism
26 teeth
262 gear rack
263 gearwheel segment
D pivoting direction
L release direction
S plugging direction
Q1 first transverse direction
Q2 second transverse direction

1. A plug arrangement, comprising a housing part for a plug which can be plugged together with a mating plug along a plugging direction, and a pivoting lever which can be attached to the housing part and, in the attached state, can be pivoted from an initial position into an end position, wherein the arrangement has a blocking element which can be transferred from a blocking position to a release position and which, in the blocking position, blocks pivoting of the pivoting lever out of the initial position and, in the release position, releases pivoting of the pivoting lever, wherein the blocking element has a driving element which can be actuated by the mating plug and with which the blocking element is transferred by the mating plug into the blocking position.

2. The plug arrangement according to claim 1, wherein the driving element comprises form-fit elements interacting with the mating plug.

3. The plug arrangement according to claim 1, wherein the driving element is configured to interact with the mating plug only in the initial position.

4. The plug arrangement according to claim 1, wherein the driving element is configured to be deactivated when the blocking element has reached the blocking position.

5. The plug arrangement according to claim 1, wherein the driving element is configured to be deactivated when a defined tensile force between the plug and the mating plug is exceeded.

6. The plug arrangement according to claim 1, wherein the blocking element is movably mounted on the pivoting lever.

7. The plug arrangement according to claim 1, wherein the blocking element comprises a securing element which is configured to automatically secure the blocking element to the housing part when the pivoting lever reaches the end position.

8. The plug arrangement according to claim 7, wherein a detaching element, with which the securing element is detached, is arranged to be inaccessible in the blocking position.

9. The plug arrangement according to claim 7, wherein the detaching element is covered by the pivoting lever in the blocking position.

10. The plug arrangement according to claim 1, wherein the blocking element can be transferred into the blocking position when the pivoting lever is in the end position.

11. The plug arrangement according to claim 1, wherein at least in the release position the blocking element is an extension element for the pivoting lever.

12. The plug arrangement according to claim 1, wherein the blocking element is pulled into the blocking position by the mating plug.

13. The plug arrangement according to claim 1, wherein the blocking element can be transferred into the release position by the mating plug.

14. The plug arrangement according to claim 1 and a housing part of a mating plug.

15. The plug arrangement according to claim 1, comprising a pulling mechanism which pulls the plug towards the mating plug when the pivoting lever is transferred from the initial position to the end position.
